(19) United States
(12) Patent Application Publication
(10) Pub. No.: US 2023/0187773 A1
(43) Pub. Date: Jun. 15, 2023

(54) BATTERY SYSTEM WITH A COVER ELEMENT FORMING A VENTING CHANNEL

(71) Applicant: SAMSUNG SDI CO., LTD., Yongin-si (KR)

(72) Inventors: Dominik MARESCH, Hausmannstaetten (AT); Florian ALTENBURGER, Weiz (AT); Rainer RETTER, Unterfladnitz (AT)

(21) Appl. No.: 18/081,338

(22) Filed: Dec. 14, 2022

(30) Foreign Application Priority Data
Dec. 15, 2021 (EP) 21214649.2
Dec. 12, 2022 (KR) 10-2022-0172897

(51) Int. Cl. H01M 50/342; H01M 50/204; H01M 50/271; H01M 10/613; H01M 10/6554; H01M 10/625; B60K 1/04

(52) U.S. Cl. CPC H01M 50/3425; H01M 50/204; H01M 50/271; H01M 10/613; H01M 10/6554; H01M 10/625; B60K 1/04; H01M 2200/20; H01M 2220/20; B60K 2001/005

(57) ABSTRACT

A battery system includes: a battery pack including a battery housing and a plurality of battery cells accommodated within the battery housing; and a cover element covering an outer side of the battery housing. The battery housing has a housing exit at where a venting gas stream exhausted by one or more of the battery cells during a thermal runaway exits the battery housing, and the cover element covers the housing exit. The cover element forms a venting channel together with the outer side of the battery housing such that the venting gas stream exiting the housing exit is received and guided by the venting channel along the outer side of the battery housing to a channel exit of the venting channel.

### CROSS-REFERENCE TO RELATED APPLICATION

This application claims priority to and the benefit of European Patent Application No. 21214649.2, filed in the European Patent Office on Dec. 15, 2021, and Korean Patent Application No. 10-2022-0172897, filed in the Korean Intellectual Property Office on Dec. 12, 2022, the entire content of both of which are incorporated herein by reference.

### BACKGROUND

### 1. Field

Aspects of embodiments of the present disclosure relate to a battery system with a cover element forming a venting channel.

### 2. Description of the Related Art

Recently, vehicles for transportation of goods and peoples have been developed that use electric power as a source for motion. Such an electric vehicle is an automobile that is propelled by an electric motor using energy stored in rechargeable (or secondary) batteries. An electric vehicle may be solely powered by batteries or may be a hybrid vehicle powered by, for example, a gasoline generator. Furthermore, the vehicle may include a combination of an electric motor and a conventional combustion engine.

Generally, an electric-vehicle battery (EVB, or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter provides an irreversible conversion of chemical to electrical energy. Low-capacity rechargeable batteries are used as power supply for small electronic devices, such as cellular phones, notebook computers, and camcorders, while high-capacity rechargeable batteries are used as power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of a plurality of unit battery cells coupled to each other in series and/or in parallel to provide a high energy density, such as for motor driving of a hybrid vehicle. For example, the battery module may be formed by interconnecting the electrode terminals of the plurality of unit battery cells in an arrangement or configuration depending on a desired amount of power and to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage. The battery modules may include submodules with a plurality of stacked battery cells, and each stack may include cells connected in parallel that are, in turn, connected in series (XpYs) or cells connected in series that are, in turn, connected in parallel (XsYp).

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

A battery system may further include a battery management system (BMS), which is an electronic system that manages the rechargeable battery, battery module, and battery pack, such as by protecting the batteries from operating outside their safe operating area (or safe operating parameters), monitoring their states, calculating secondary data, reporting that data, controlling its environment, authenticating it, and/or balancing it. For example, the BMS may monitor the state of the battery as represented by voltage (such as total voltage of the battery pack or battery modules, voltages of individual cells, etc.), temperature (such as average temperature of the battery pack or battery modules, coolant intake temperature, coolant output temperature, or temperatures of individual cells, etc.), coolant flow (such as flow rate, cooling liquid pressure, etc.), and current. Additionally, a BMS may calculate values based on the above items, such as minimum and maximum cell voltage, state of charge (SoC) or depth of discharge (DoD) to indicate the charge level of the battery, state of health (SoH; a variously-defined measurement of the remaining capacity of the battery as % of the original capacity), state of power (SoP; the amount of power available for a defined time interval given the current power usage, temperature, and other conditions), state of safety (SoS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. The BMS may be also distributed, in which a BMS board is installed at each cell with just a single communication cable between the battery and a controller. Or the BMS may have a modular construction including a few controllers, each handling a certain number (e.g., a group or subset) of cells with communication between the controllers. Centralized BMSs are most economical but are least expandable and are plagued by a multitude of wires. Distributed BMSs are the most expensive but are simplest to install and offer the cleanest assembly. Modular BMSs offer a compromise of the features and problems of the other two topologies.

A BMS may protect the battery pack from operating outside its safe operating area. Operation outside the safe operating area may be indicated by over-current, over-voltage (e.g., during charging), over-temperature, under-temperature, over-pressure, and ground fault or leakage current detection. The BMS may prevent (or mitigate) operation outside the battery's safe operating area by including an internal switch, such as a relay or solid-state device, which opens if the battery is operated outside its safe operating area, by requesting the devices to which the battery is connected to reduce or even terminate using the battery, and by actively controlling the environment, such as through heaters, fans, air conditioning, or liquid cooling.

A thermal management system provides thermal control of the battery pack to safely use the battery module by efficiently emitting, discharging, and/or dissipating heat generated by its rechargeable batteries. If the heat emission/discharge/dissipation is not sufficiently performed, temperature deviations may occur between respective battery cells such that the battery module may no longer generate a desired amount of power. In addition, an increase of the internal temperature can lead to abnormal reactions occurring therein and, thus, charging and discharging performance of the rechargeable deteriorates and the life-span of the rechargeable battery is shortened.

Exothermic decomposition of cell components may lead to a so-called thermal runaway. Generally, thermal runaway refers a process that is accelerated by increased temperature, in turn releasing energy that further increases temperature. Thermal runaway occurs in situations where an increase in temperature changes cell conditions in a way that causes further increase in temperature, often leading to a destructive result. In rechargeable battery systems, thermal runaway is associated with strongly exothermic reactions that are accelerated by temperature rise. These exothermic reactions include combustion of flammable gas compositions within the battery pack housing. For example, when a cell is heated above a critical temperature (for example, above about 150° C.) it can transition into a thermal runaway. The initial heating may be caused by a local failure, such as a cell internal short circuit, heating from a defective electrical contact, short circuit to a neighboring cell, etc. During the thermal runaway, a failed battery cell (e.g., a battery cell which has a local failure) may reach a temperature exceeding about 700° C. Further, large quantities of hot gas are ejected from inside of the failed battery cell through the venting opening in the cell housing into the battery pack. The main components of the vented gas are H₂, CO₂, CO, electrolyte vapor and other hydrocarbons. The vented gas is therefore flammable and potentially toxic. The vented gas also causes a gas-pressure increase inside the battery pack.

Generally, the hot venting gas stream of a battery cell in thermal runaway escapes through a system exit including a housing venting valve to the outside (e.g., the environment of the battery housing). Due to the high temperatures of the venting gas stream of up to about 1,000° C., the venting gas stream may pose a risk for any bystanders when exiting the system exit. For example, there is a risk of deflagration of the venting gas at the system exit, which may lead to damage of external components and to injuries to bystanders or service personnel.

### SUMMARY

The present disclosure is defined by the appended claims and their equivalents. Any disclosure outside such scope is intended for illustrative as well as comparative purposes.

According to one embodiment of the present disclosure, a battery system includes a battery pack including a battery housing and a plurality of battery cells accommodated within the battery housing, a housing exit of the battery housing where a venting gas stream exhausted by one or more of the battery cells during a thermal runaway exits the battery housing through the housing exit, a cover element covering an outer side of the battery housing including the housing exit, the cover element forming a venting channel with the outer side of the battery housing such that the venting gas stream exiting the housing exit is received and guided by the venting channel along the outer side of the battery housing to a channel exit of the venting channel.

According to another embodiment of the present disclosure, an electric vehicle including the battery system is provided.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments of the present disclosure with reference to the attached drawings, in which:

FIG. 1 is a schematic perspective view of a battery system according to an embodiment.

FIG. 2 is a schematic exploded view of some parts of the battery system shown in FIG. 1.

FIG. 3 is a schematic cross section of a lower part of a battery system shown in FIGS. 1 and 2.

### DETAILED DESCRIPTION

Reference will now be made in detail to embodiments, examples of which are illustrated in the accompanying drawings. Aspects and features of the embodiments, and implementation methods thereof, will be described with reference to the accompanying drawings. In the drawings, like reference numerals denote like elements, and redundant descriptions thereof may be omitted. The present disclosure, however, may be embodied in various different forms and should not be construed as being limited to the embodiments illustrated herein. Rather, these embodiments are provided as examples so that this disclosure will be thorough and complete, and will fully convey the aspects and features of the present disclosure to those skilled in the art.

Processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

As used herein, the terms “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “have,” “include,” “comprise,” “having,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a battery pack including a battery housing accommodating a plurality of battery cells. The battery cells may be interconnected via busbars contacting respective electrode terminals of the battery cells to form one or more battery modules as explained above. The battery cells may be, for example, prismatic or cylindrical cells. The battery cells have venting exits at a venting side of the battery cells, and the venting exits allow a venting gas stream to escape the battery cells during a thermal runaway. Venting valves may be provided at (or in) the venting exits. The battery system further includes a housing exit through which the venting gas stream may leave the battery housing. The housing exit may be part of the battery housing. A burst membrane may be arranged at (or in) the housing exit as will be explained in more detail below.

The battery system further includes a cover element that is arranged to cover an outer side of the battery housing and the housing exit. The outer side of the battery housing may be an underside of the battery housing. The housing exit is arranged at the outer side of the battery housing. The cover element covers not only the housing exit but also at least a part of the outer side of the battery housing. A venting channel is formed by the cover element and the outer side of the battery housing, which receives and guides the venting gas stream leaving the housing exit along the outer side of the battery housing to a channel exit of the venting channel. For example, the cover element may have a space that forms the venting channel together with the outer side of the battery housing. In other words, the venting channel may be delimited by channel walls formed by the cover element and by the outer side of the battery housing. The cover element may be understood as a venting device.

The venting gas stream is directed along the outer side of the battery housing along a path (e.g., a predefined path). The venting gas stream flowing along the venting channel may transfer heat to the walls of the venting channel (e.g., to the cover element and to the outer side of the battery housing). The venting gas stream may directly contact the outer side of the battery housing without any side wall of the cover element in between shielding the outer side of the battery housing from the venting gas stream. Thus, the venting gas stream may transfer heat not only to the cover element but also directly to the outer side of the battery housing and, therefore, may be sufficiently cooled down before the venting gas stream exits the venting channel through the channel exit. A system exit may be arranged downstream of the channel exit for venting the venting gas stream to the environment. The channel exit may form such a system exit.

Thus, the venting gas of the venting gas stream may be sufficiently cooled down before leaving the battery system through the channel or system exit so that it does not pose a risk to any bystanders. In particular, the risk of deflagration may be significantly reduced. The outer side of the battery housing may be configured to receive heat from the venting gas stream. For example, the outer side of the battery housing may have relatively high thermal conductivity, such as higher thermal conductivity than the cover element. Further, because the cover element does not provide a fully formed venting channel itself but forms the venting channel together with the outer side of the battery housing, the cover element can be simply attached to the battery housing. This simplifies the installation and allows the cover element to be retrofitted to existing battery packs. Furthermore, when the cover element is simply attached to the outside of the battery housing, the number of sealing interfaces may be reduced. Thus, a proper venting configuration is provided using a reduced number of parts and, thus, reduced complexity and reduced costs with respect to previous designs. Also, the cover element is suited for or easily adaptable to different battery packs. For example, the cover element may be provided in different sizes for different battery packs. The cover element can be tailored easily for various battery pack designs in terms of build-in situations and energy contents (e.g., vent gas amount). By configuring of a defined number of parts, numerous possible venting designs are possible.

According to an embodiment, the channel exit provided by the cover element is laterally offset with respect to the housing exit of the battery housing. For example, the channel exit and the housing exit are not aligned with one another but are offset from one another. As a result of the channel exit and the housing exit being laterally offset, the venting gas stream leaving the housing exit does not travel along a straight path to the channel exit but along a curved path. In particular, the cover element, and thus, the venting channel, may be configured such that the venting gas stream is redirected after leaving the housing exit at least one time, but in some embodiments, two or more times, before reaching the channel exit. This ensures that the venting gas stream flows along the venting channel at least a minimum distance so that it may transfer sufficient heat to the channel walls (e.g., to the cover element and the outer side of the battery housing). Thus, the venting gas stream is sufficiently cooled down before leaving the system exit.

According to an embodiment, the venting channel includes a rampart member surrounding (e.g., surrounding in a plan view or extending around a periphery of) the channel exit at least in part such that the venting gas stream coming from the housing exit is guided around and/or above the rampart member before reaching the channel exit. The rampart member forms an elevation or obstacle in the venting channel that the venting gas stream has to overcome to reach the channel exit. The rampart member may at least partly shield the channel exit from the venting gas stream such that the venting gas stream may need to divert from a main flow direction. The rampart member may form a circular wall around the channel exit such that the venting gas stream flowing along the main flow direction hits against the rampart member and is diverted in an upwards direction above the rampart member and/or along a circle around the rampart member to overcome the rampart member to reach the channel exit. The circular wall may have an opening at a side pointing away from the housing exit from which the venting gas stream is coming such that the venting gas stream being diverted around the rampart member passes the rampart member. The rampart member therefore prolongs (or extends) the path the venting gas stream needs to take before reaching the channel exit. Also, diverting the venting gas stream may induce turbulence into the venting gas stream. Both of these effects lead to better heat transfer to the channel walls (e.g., to the cover element and to the outer side of the battery housing) and, thus, further cooling of the venting gas stream. Aside from such heat transfer of vent gas at elevated temperatures, glowing particles vented from the cells have more time cool down before they leave the battery system. This reduces the risk of these particles igniting when leaving the system exit and coming into contact with fresh air outside of the battery system. Such an ignition would otherwise propagate back into the battery pack, leading to damage of the cells or other elements.

According to an embodiment, the battery system includes a cooling plate arranged at the outer side of the battery housing and facing the cover element. The outer side of the battery housing may be formed at least in part by the cooling plate, such as a cooling plate which is actively cooled via a cooling liquid. Thus, the cooling plate may be covered by the cover element at least in part and may act as part of the channel wall of the venting channel. The venting gas stream is, thus, directed along the cooling plate in direct contact with the cooling plate, which provides even better heat transfer and cooldown of the venting gas stream. The cooling plate may act as a cooling plate for the battery cells as well. The cooling plate may, thus, cool not only the battery cells arranged at a first side of the cooling plate but also the venting gas stream flowing along a second side of the cooling plate opposite to the first side.

According to an embodiment, the battery system includes a burst membrane covering the housing exit of the battery housing. The burst membrane is configured to burst upon an inside pressure in the battery housing reaching a burst pressure during a thermal runaway. The burst membrane may seal the battery housing to the outside so that no foreign bodies or contaminations can enter through the housing exit into the battery housing. The burst membrane may be configured to prevent water from entering the housing exit. The burst membrane is, however, pressure sensitive such that a sudden pressure rise inside the battery housing, as may occur during thermal runaway of one or more of the battery cells, leads to the burst pressure being reached or exceeded and the burst membrane bursting open so that the venting gas stream may exit the housing exit towards the venting channel.

According to an embodiment, the burst membrane is sealed directly to the battery housing. For example, the burst membrane is attached directly to the battery housing, such as to the outside of the battery housing, covering the housing exit. The burst membrane itself may sufficiently seal the housing exit against the above-mentioned foreign bodies or contaminations, such as when the burst membrane is self-adhesive. Thus, according to an embodiment, the burst membrane is self-adhesive. Also, a separate sealing member may be provided (e.g., a sealing ring), and the sealing ring may surround the housing exit. The burst membrane covers the sealing ring and the housing exit. Attaching the burst membrane, such as a self-adhesive burst membrane, directly to the battery housing allows for a simple installation of the burst membrane. Also, such a burst membrane is suitable for or may be configured to, for example, cut to respective sizes, many different battery packs and/or housing exit sizes.

According to an embodiment, the burst membrane is gas-permeable such that gas may transmit the burst membrane even when the pressure is below the burst pressure. Thus, slow pressure changes and/or small pressure difference between the inside of the battery housing and the outside of the battery housing may be equalized by a gas transfer through the intact burst membrane. For example, overpressure inside the battery housing may occur due to ageing of the battery cells, and build-up of such an overpressure may be prevented by the gas-permeable burst membrane.

According to an embodiment, the burst membrane is configured to bulge outwardly upon the inside pressure in the battery housing reaching the burst pressure, and the cover element may include a burst pin arranged to pierce the burst membrane when bulged outwardly. Thus, the burst membrane may burst due to contact with the burst pin. When a thermal runaway occurs inside the battery housing, the burst membrane bulges outwardly so much that it contacts the burst pin, and the burst pin pierces the burst membrane and causes the burst membrane to burst. The burst pin may form part of the cover element; for example, the burst pin may be formed as one-piece with (or integral with) the cover element by, as one example, injection molding, which allows for a simple construction, such as when providing an existing battery housing with the cover element and the burst membrane.

According to an embodiment, the cover element is sealed directly to the outer side of the battery housing. For example, the cover element is attached directly to the outer side of the battery housing. A separate sealing member may be provided, such as a sealing ring, and the sealing member may seal the cover element against the battery housing such that a gas-tight venting channel is formed. This further simplifies the installation of the cover element. Also, such an installation of the cover element allows the cover element to be used for or to be configured to many different battery packs and/or housing exit sizes. The cover element can easily be retrofitted to existing battery packs.

According to an embodiment, the battery system includes a sealing member surrounding the channel exit at an outer side of the channel exit to seal the channel exit against an underbody of a vehicle. For example, the sealing member may be provided at an outer side wall member of the cover element, and the side wall member may form the channel exit. Thus, a safe and gas-tight connection with the vehicle may be achieved so that the venting gas stream may be safely guided to the outside.

The present disclosure further pertains to a cover element that is configured to be attached to an outer side of a battery housing, and the cover element may be configured to form a venting channel with the outer side of the battery housing for receiving and guiding a venting gas stream exiting a housing exit of the battery housing along the outer side of the battery housing towards a channel exit of the cover element. The cover element may further include a sealing member to be sealed towards the outer side of the battery housing, a rampart member to divert the venting gas stream, and/or a burst pin to burst in case of a thermal runaway a burst membrane covering the housing exit.

The present disclosure further pertains to an electric vehicle including the battery system as explained above and below.

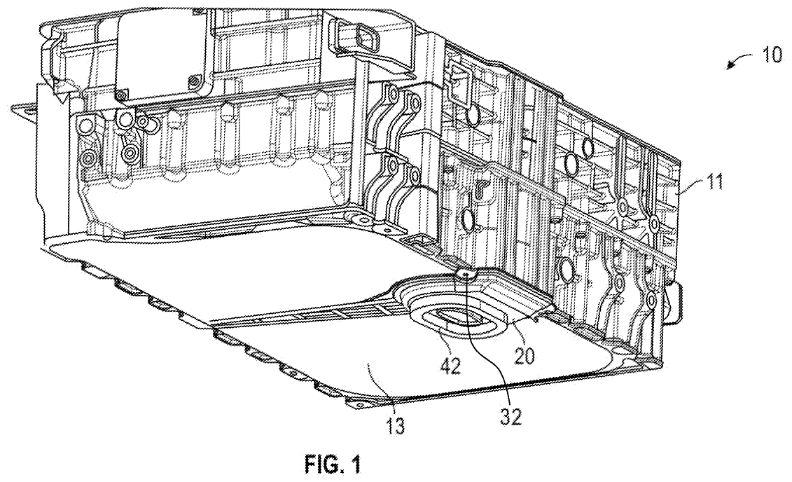

The figures illustrate a battery system according to an embodiment of the present disclosure. The battery system includes a battery pack 10 including a battery housing 11 and a plurality of battery cells 12 accommodated within the battery housing 11. The battery pack 10 may be a traction battery for an electric vehicle. FIG. 1 shows the battery system in a perspective view from below. As can be seen in FIG. 1, the battery system includes a cover element 20 attached to the outer side 13, here the underside, of the battery housing 11.

A housing exit 14 of the battery housing 11 is arranged at an end of a guide channel 15, through which a venting gas stream exhausted by one or more of the battery cells 12 during a thermal runaway is guided to exit the battery housing 11 through the housing exit 14 at the outer side 13. A burst membrane 16 is arranged at the housing exit 14, which is sealed directly to the underside of the battery housing 11 via a sealing member 18. The burst membrane 16 prevents contaminants, such as water, from entering the housing exit 14.

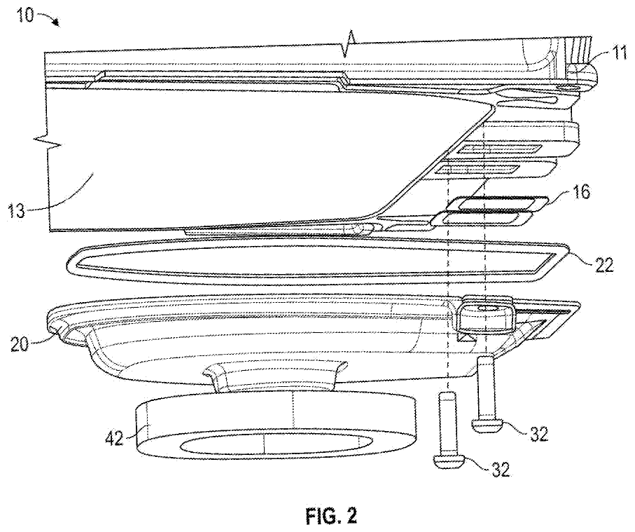

The cover element 20 covers the housing exit 14 of the battery housing 11 (see, e.g., FIG. 2) and in part the outer side 13 of the battery housing 11. The cover element 20 is sealed directly to the outer side 13 via a sealing member 22, as can be seen in, for example, FIG. 2. The cover element 20 includes (or forms) a space 23 forming a venting channel 24 with the outer side 13 of the battery housing 11. For example, the venting channel 24 is delimited not only by the cover element 20 but also, at an upper end thereof, by the outer side 13 of the battery housing 11. The cover element 20 may be fixed to the battery housing 11 via screws 32.

The cover element 20 may further include a burst pin 26 arranged such that it pierces the burst membrane 16 when the burst membrane 16 bulges outwardly due to an inside pressure in the battery housing 11 (e.g., the guide channel 15) reaching a burst pressure. Thus, when the pressure inside the guide channel 15 raises due to, for example, a thermal runaway, the burst membrane 16 bursts, allowing the venting gas stream to exit the battery housing 11 at the housing exit 14.

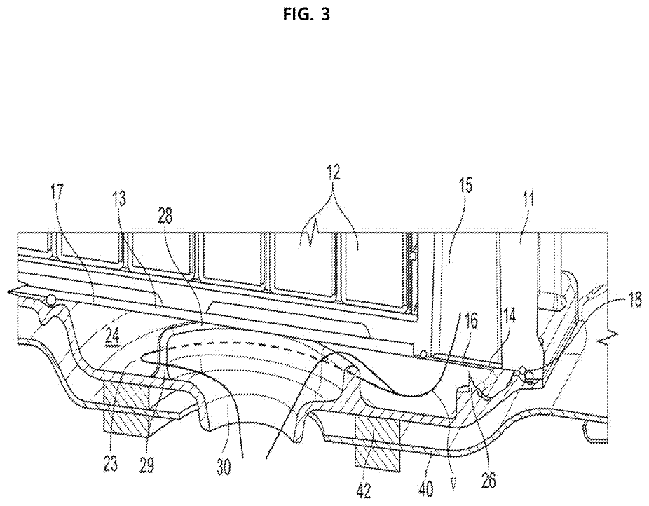

The venting gas stream V exiting the housing exit 14 is received and guided by the venting channel 24 along the outer side 13 of the battery housing 11 to a channel exit 30 of the venting channel 24. The channel exit 30 is laterally offset with respect to the housing exit 14, as shown in, for example, FIG. 3. The venting gas stream may transfer heat energy to the channel walls (e.g., to the cover element 20 and to the battery housing 11) to be cooled. The outer side 13 of the battery housing 11 may be provided by a cooling plate 17 for cooling the battery cells 12. The cooling plate 17 may be a heat sink, such as if it is actively cooled.

The cover element 20 further includes a rampart member 28 in the form of a circular wall having an opening 29 arranged at a side of the rampart member 28 opposite the side facing the housing exit 14. The opening 29 may be formed by penetrating or cutting a portion of the rampart member 28. The rampart member 28 surrounds the channel exit 30, providing an obstacle for the venting gas stream V such that the venting gas stream V is diverted around the rampart member 28 through the opening 29 and above the rampart member 28 to reach the channel exit 30 as indicated in, for example, FIG. 3. This leads to a longer venting path and creates turbulence in the venting gas stream and, therefore, to better heat transfer to the channel walls.

The cover element 20 is further sealed to an underbody 40 of a vehicle via a sealing member 42 surrounding the channel exit 30 at an outer side of the channel exit 30. Thus, a safe and gas-tight connection with the vehicle may be achieved so that the venting gas stream may be safely guided to the outside.

Thus, in the battery system according to embodiments of the present disclosure, the venting gas of the venting gas stream may be sufficiently cooled down before leaving the battery system through the channel or system exit so as not to pose a risk to any bystanders. In particular, the risk of deflagration may be significantly reduced.

Further, because the cover element 20 does not provide a fully formed venting channel but forms the venting channel together with the outer side of the battery housing 11, the cover element 20 can be simply attached to the battery housing 11. This simplifies the installation and allows the cover element 20 to be retrofitted to existing battery packs 10. Furthermore, because the cover element 20 may be simply attached to the outside of the battery housing, the number of sealing interfaces may be reduced. A proper venting solution is provided with a reduced number of parts and, thus, reduced complexity and reduced costs with respect to known designs. Also, the cover element 20 is suited for or easily adaptable to different battery packs by, for example, being provided in different sizes. The cover element 20 can be tailored easily for many different battery pack designs in terms of build-in situations and energy contents (e.g., vent gas amount) by configuration of a defined number of parts.

### SOME REFERENCE NUMERALS

10 battery pack

11 battery housing

12 battery cells

13 outer side of battery housing

14 housing exit

15 guide channel

16 burst membrane

17 cooling plate

18 sealing member

20 cover element

22 sealing member

23 space

24 venting channel

26 burst pin

28 rampart member

30 channel exit

32 screws

40 underbody of vehicle

42 sealing member

What is claimed is:

1. A battery system comprising:
a battery pack comprising a battery housing and a plurality of battery cells accommodated within the battery housing; and
a cover element covering an outer side of the battery housing,
wherein the battery housing has a housing exit at where a venting gas stream exhausted by one or more of the battery cells during a thermal runaway exits the battery housing, and
wherein the cover element covers the housing exit, the cover element forming a venting channel together with the outer side of the battery housing such that the venting gas stream exiting the housing exit is received and guided by the venting channel along the outer side of the battery housing to a channel exit of the venting channel.

2. The battery system according to claim 1, wherein the channel exit in the cover element is laterally offset with respect to the housing exit of the battery housing.

3. The battery system according to claim 1, wherein the venting channel comprises a rampart member at least partially extending around a periphery of the channel exit such that the venting gas stream coming from the housing exit is guided around and/or above the rampart member before reaching the channel exit.

4. The battery system according to claim 1, wherein the battery system further comprises a cooling plate forming the outer side of the battery housing, the cooling plate facing the cover element.

5. The battery system according to claim 1, wherein the battery system further comprises a burst membrane covering the housing exit of the battery housing, and
wherein the burst membrane is configured to burst when a pressure inside the battery housing reaches a burst pressure.

6. The battery system according to claim 5, wherein the burst membrane is sealed directly to the battery housing.

7. The battery system according to claim 6, wherein the burst membrane is self-adhesive.

8. The battery system according to claim 5, wherein the burst membrane is gas-permeable such that gas may transmit the burst membrane even when the pressure inside the battery housing is below the burst pressure.

9. The battery system according to claim 5, wherein the burst membrane is configured to bulge outwardly when the pressure inside the battery housing reaches the burst pressure, and
wherein the cover element comprises a burst pin arranged to pierce the burst membrane when it bulges outwardly.

10. The battery system according to claim 1, wherein the cover element is sealed directly to the outer side of the battery housing.

11. The battery system according to claim 1, wherein the battery system further comprises a sealing member extending around a periphery of the channel exit at the outer side of the battery housing to seal the channel exit.

12. An electric vehicle comprising the battery system according to claim 1.

13. A cover element configured to be attached to an outer side of a battery housing, the cover element configured to form a venting channel with the outer side of the battery housing for receiving and guiding a venting gas stream exiting a housing exit of the battery housing along the outer side of the battery housing towards a channel exit of the cover element.
